(19) United States
(12) Patent Application Publication
(10) Pub. No.: US 2008/0131578 A1
(43) Pub. Date: Jun. 5, 2008

(54) FOOD OR DRINK PRODUCTS, SUPPLEMENTS OR ADDITIVES PRODUCED FROM HIGH GLUCORAPHANIN-CONTAINING BROCCOLI VARIETY 'HOPKINS'

(75) Inventors: Dan Caudill, Louisville, KY (US); Mark Farnham, Charleston, SC (US); Greg Rieder, Salem, OR (US)

Correspondence Address: FOLEY AND LARDNER LLP;SUITE 500, 3000 K STREET NW, WASHINGTON, DC, 20007, US

(73) Assignees: Caudill Seed and Warehouse Company, Inc.; U.S. Government, as represented by the Secretary of Agriculture

(21) Appl. No.: 11/927,113

(22) Filed: Oct. 29, 2007

Related U.S. Application Data
(60) Provisional application No. 60/854,691, filed on Oct. 27, 2006.

(51) Int. Cl. A23L 1/39; A23L 1/00; A23F 3/34; A23L 2/02

(52) U.S. Cl. 426/589; 426/665; 426/618; 426/597; 426/599; 426/653; 426/615

(57) ABSTRACT

High concentrations of glucoraphanin, and its isothiocyanate derivative, sulforaphane, can be obtained from whole plants, plant parts or extracts obtained from a new and distinct, highly inbred, and highly self-compatible Brassica oleracea L. (Italica group) broccoli variety designated ‘Hopkins’. The new broccoli variety ‘Hopkins’ produces consistent yields of seed with a consistent high glucoraphanin concentration of greater than 60 μmole of glucoraphanin per gram of seed (with an average range of 68-85 μmole of glucoraphanin per gram of seed) when analyzed by Hydrophilic Interaction Liquid Chromatography (HILIC) and greater than 80 μmol of glucoraphanin per gram of seed (with an average range of 85-105 μmole of glucoraphanin per gram of seed) when analyzed by C₁₈ Reverse-Phase HPLC.

### CROSS-REFERENCE TO RELATED PATENT APPLICATIONS

This application claims priority from Provisional Application U.S. Application 60/854,691, filed Oct. 27, 2006, incorporated herein by reference in its entirety.

### STATEMENT REGARDING FEDERALLY SPONSORED RESEARCH OR DEVELOPMENT

This invention was made with U.S. Government support under a Cooperative Research and Development Agreement (CRADA) between the Agricultural Research Service of the U.S. Department of Agriculture and Caudill Seed Company. The U.S. Government has certain rights in this invention, as provided by the terms of CRADA No. 58-3K95-2-944, entitled “Identification and Utilization of Inbred, Self-Compatible Broccoli Lines that Produce High Yields of Uniform Seed with Consistent Glucoraphanin Content”, (Dan Caudill, Principal Investigator; Mark W. Farnham, USDA Researcher).

### BACKGROUND OF THE INVENTION

1. Field of the Invention

The present invention relates to the field of cancer protection. In particular, this invention relates to the method for producing a new, distinct, highly inbred and highly self-compatible green sprouting broccoli variety, botanically known as Brassica oleracea L. of the Italica Group, and hereinafter referred to by the variety denomination ‘Hopkins’, from which glucoraphanin and sulforaphane can be obtained.

The new broccoli variety ‘Hopkins’ contains significant quantities of chemoprotective compounds that modulate mammalian enzymes involved in the metabolism of carcinogens. The chemoprotective compounds induce the activity of Phase 2 enzymes, without inducing biologically significant activities of Phase 1 enzymes that activate carcinogens. More specifically, ‘Hopkins’ was selectively produced to contain an increased glucoraphanin concentration, and therefore, is a potent source of the chemoprotective agent, sulforaphane.

This invention further provides for consistent yields of seed produced by the new broccoli variety ‘Hopkins’ which consistently contain greater than 60 μmole of glucoraphanin per gram of seed (with an average range of 68-85 μmole of glucoraphanin per gram of seed) when analyzed by Hydrophilic Interaction Liquid Chromatography (HILIC) and greater than 80 μmole of glucoraphanin per gram of seed (with an average range of 85-105 μmole of glucoraphanin per gram of seed) when analyzed by C₁₈ Reverse-Phase High Performance Liquid Chromatography (HPLC). The primary use of the new broccoli variety ‘Hopkins’ is for production of high quality broccoli seed, well suited for making broccoli seedling sprouts with consistently high glucoraphanin content and high chemoprotective value, as well as, food or drink products, supplements or additives with high glucoraphanin content by utilizing the seeds or sprouts, or different extracts from the seeds or sprouts produced by the new broccoli variety ‘Hopkins’.

2. Background

Phytochemicals, naturally occurring and biologically active plant compounds that provide health benefits, are receiving increasing attention as possible anti-cancer agents. Research has revealed that cruciferous vegetables contain a rich source of phytochemicals that may provide cancer chemoprotection, by both reducing the risk of developing several types of cancer and initiating cancer cell apoptosis. (Beecher, Am. J. Clin. Nutr., 59(suppl): 1166-70 (1994); Brooks et al., Cancer Epidemiology, Biomarkers & Prevention, September, 10:949-954 (2001); Fahey & Talalay, Phytochemicals and Health, D L Gustine, H E Flores, eds. Rockville, Md.: American Society of Plant Physiologists (1995); Fahey et al., Nutrition Reviews, 57(9) (Part II), September (1999); Fahey et al., Phytochemistry, 56:5-51 (2001); Fahey et al., Proc. Natl. Acad. Sci. USA, May 28; 99(11):7610-7615 (2002); Gamet-Payrastre, et al. Cancer Research, March 1; 60(5):1426-1433 (2000); Michaud et al., J. Natl. Cancer Inst. 91:605-613 (1999); Prochaska et al., Proc. Natl. Acad. Sci. USA, March 15; 89(6):2394-8 (1992); Singletary & MacDonald, Cancer Letters, July 3, 155(1):47-54 (2000); and Talalay and Fahey, Amer. Soc. Nutr. Sci. (suppl), 3027-3033s. (2001). Accordingly, research studies have been conducted and have shown that populations which eat diets rich in cruciferous vegetables, such as broccoli, may have reduced rates of cancer. (Fahey et al., Proc. Natl. Acad. Sci. USA, September 16, 94:10367-72 (1997) and Terry et al., JAMA, 285:2975-86 (2001)).

Increased interest in the potential chemoprotective benefit of phytochemicals found in cruciferous vegetables has stimulated research programs focused on analyzing, selecting, and breeding different vegetables with higher cancer protective phytochemical content. (U.S. Pat. No. 6,340,784; and Farnham, “A Comprehensive Program to Enhance Glucoraphanin Content of Broccoli Heads and Seed. Proc. Of the Int'l. Sym. on Human Health Effects of Fruits and Vegetables. 17-20 Aug. 2005 Quebec City, Quebec, Canada. P. 30 (Abstract)). In particular, glucosinolates, phytochemicals that may be converted by enzymatic action to isothiocyanates, have been identified as having anti-cancer potential. (Zhang et al., Proc. Natl. Acad. Sci. USA, April 12, 91(8):3147-50 (1994)). For example, sulforaphane, an isothiocyanate derivative of glucoraphanin, provides chemoprotection through the ability to induce Phase 2 detoxification enzymes in mammals. (U.S. Pat. Nos. 5,725,895; 5,968,505; 5,968,567 and 6,521,818; and Zhang et al., Proc. Natl. Acad. Sci. USA, 89:2399-403 (1992)).

Highly efficient methods have been developed for measuring the potency of plant extracts to increase or induce the activities of Phase 2 enzymes. (Prochaska et al., Anal. Biochem. 169: 328-336 (1988) and Prochaska et al., 1992). In addition, these methods have been employed for isolating the phytochemical compounds responsible for the inducer activities in plants and for evaluating the anticarcinogenic activities of these compounds. (Zhang et al., Proc. Natl. Acad. Sci. USA, 89: 2399-2403 (1992) and Posner et al., J. Med. Chem., 17: 170-175 (1994)).

Brassica oleracea L. broccoli of the Italica Group is a recognized cruciferous vegetable which contains a high potency of natural chemoprotection phytochemicals. Brassica oleracea L. broccoli varieties contain relatively high levels of glucoraphanin, and its isothiocyanate breakdown product, sulforaphane (Beecher, Am. J. Clin. Nutr., 59(suppl.):1166-70 (1994); Carlson et al., J. Amer. Soc. Hort. Sci. 112(1): 173-78 (1987); Farnham et al., J. of Amer. Soc. Of Horticultural Science, 125:482-88 (2000); Faulkner et al. Carcinogenesis, 19(4): 605-09 (1998); Kushad et al., J. Agric. Food Chem. 47: 1541-48 (1999); West et al., J. Agric. Food Chem., publ. on web, pp. 1-11 (2004)). Glucoraphanin is one of the most abundant glucosinolates in broccoli. Its cognate isothiocyanate is sulforaphane, a potent inducer of mammalian detoxification by inducing Phase 2 enzymatic activity. (U.S. Pat. Nos. 5,725,895; 5,968,505; 5,968,567 and 6,521,818; and Zhang et al., Proc. Natl. Acad. Sci. USA, 89:2399-403 (1992)). Thus, glucoraphanin and sulforaphane found in broccoli, may help to explain the scientific evidence indicating that populations consuming a diet rich in fruits and vegetables, and especially cruciferous vegetables such as broccoli, have a reduced risk of developing several types of cancer.

Breeding programs targeting broccoli varieties of Brassica oleracea L. were undertaken to enhance the natural amount of phytochemicals, such as glucoraphanin in plant material. Initial breeding programs focused on increasing the levels of glucoraphanin found in the vegetable heads of broccoli. However, as a result of the discovery that broccoli seeds and seedling sprouts contain glucoraphanin concentrations from 10 to 100 greater than mature broccoli heads (Brooks et al., 2001; Fahey and Talalay, Food Chem. Toxicol., 37:973-79 (1999); Fahey et al, 1997; Fahey et al., 1999; West et al., 2004), some breeding programs are focusing on producing new broccoli varieties which produce consistent yields of seed with consistently high concentrations of glucoraphanin.

There is a need in the art to identify particular broccoli varieties that yield high levels of Phase 2 enzyme-inducer activity for chemoprotection. There is also a need to identify particular broccoli varieties that produce an increased concentration of glucosinolate in market stage plant parts, such as seeds, sprouts or heads, that can be incorporated into food or drink products, supplements or additives, or extracts or powder made therefrom and incorporated into food or drink products, supplements or additives to provide increased chemoprotection.

It is therefore desirable to produce broccoli varieties which possess consistent quantities of chemoprotectant activity. It is also desirable to produce broccoli varieties which possess consistent, high quality chemoprotectant activity. Such broccoli varieties can include open-pollinated and inbred broccoli lines which contain high levels of alkylthioalkyl glucosinolates relative to the levels of indole glucosinolates.

### SUMMARY OF THE INVENTION

The present invention provides for the method of producing a food or drink product, supplement or additive comprising the step of incorporating plant parts or whole plants from the Brassica oleracea L. (Italica group) broccoli variety ‘Hopkins’ into said food or drink product, supplement or additive.

Another aspect of the present invention provides for the above method wherein said plant parts are selected from the group consisting of seeds, sprouts, leaves and mature heads.

Another aspect of the present invention provides for the above method wherein said plant parts are seeds with a glucoraphanin concentration, expressed as micromoles of glucoraphanin per gram of seed, with at least about 50 μmol/g, about 55 μmol/g, about 60 μmol/g, about 65 μmol/g, about 70 μmol/g, about 75 μmol/g, about 80 μmol/g, about 85 μmol/g, about 90 μmol/g, about 95 μmol/g, about 100 μmol/g, about 105 μmol/g, about 110 μmol/g, about 115 μmol/g, about 120 μmol/g, about 125 μmol/g, about 130 μmol/g, about 135 μmol/g, about 140 μmol/g, about 145 μmol/g, about 150 μmol/g, about 155 μmol/g, about 160 μmol/g, about 165 μmol/g, about 170 μmol/g, about 175 μmol/g, about 180 μmol/g, about 185 μmol/g, about 190 μmol/g, about 200 μmol/g, any integer between 50 and 200 μmol/g, or more than 200 μmol/g.

Another aspect of the present invention provides for the above method, wherein said food or drink product, supplement or additive is selected from the group consisting of juices, smoothies, shakes, teas, soups, sauces, sandwiches, salads, granolas, cereals, breads, other baked goods, fried goods, pills and tablets, sprays and other ingestible products, supplements and additives.

Another aspect of the present invention provides for the above method, wherein said step of incorporation is combining said plant parts or whole plants with other ingredients.

Another aspect of the present invention provides for the above method, wherein said step of incorporation is drying or grinding said plant parts or whole plants and then combining with other ingredients.

Another aspect of the present invention provides for the above method, wherein said step of incorporation is extraction of said plant parts or whole plants with a solvent to obtain glucosinolates or isothiocyanates and combining said glucosinolates or isothiocyanates extract with other ingredients.

Another aspect of the present invention provides for a food or drink product, supplement or additive comprising plant parts or whole plants from the broccoli variety ‘Hopkins’.

Another aspect of the present invention provides for a food or drink product, supplement or additive comprising an extract obtained from plant parts or whole plants of the broccoli variety ‘Hopkins’.

### BRIEF DESCRIPTION OF THE DRAWINGS

The patent or application file contains at least one drawing executed in color. Copies of this patent or patent application publication with color drawings will be provided by the Office upon request and payment of the necessary fees.

FIG. 1. A top view perspective of a row of several, whole ‘Hopkins’ broccoli plants grown in the field, at about fresh market stage maturity.

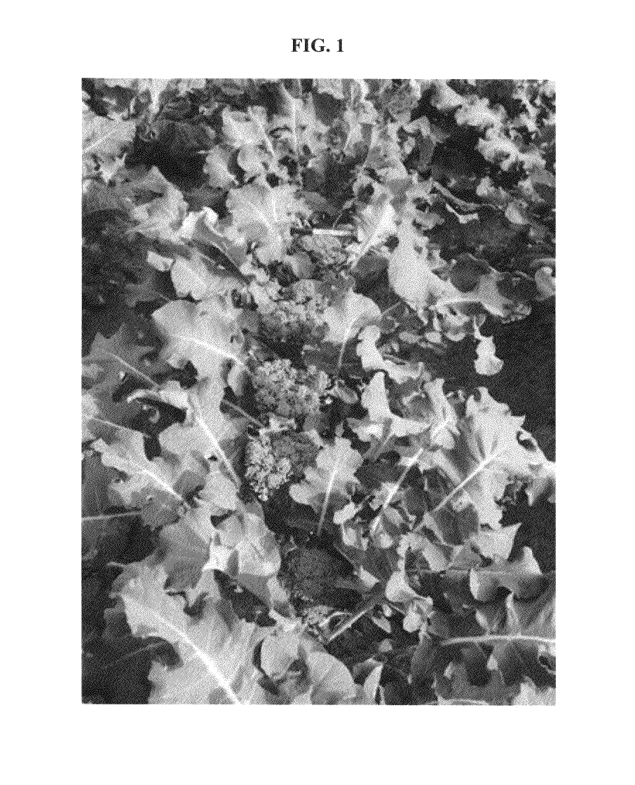

FIG. 2. A close-up top view perspective of a row of several, whole ‘Hopkins’ broccoli plants grown in the field, at about fresh market stage maturity.

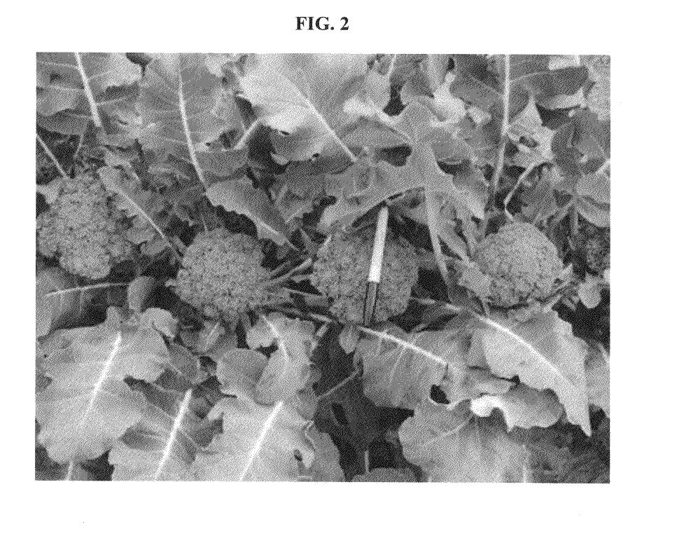

FIG. 3. A side-top view perspective of a row of several, whole ‘Hopkins’ broccoli plants grown in the field, at about fresh market stage maturity.

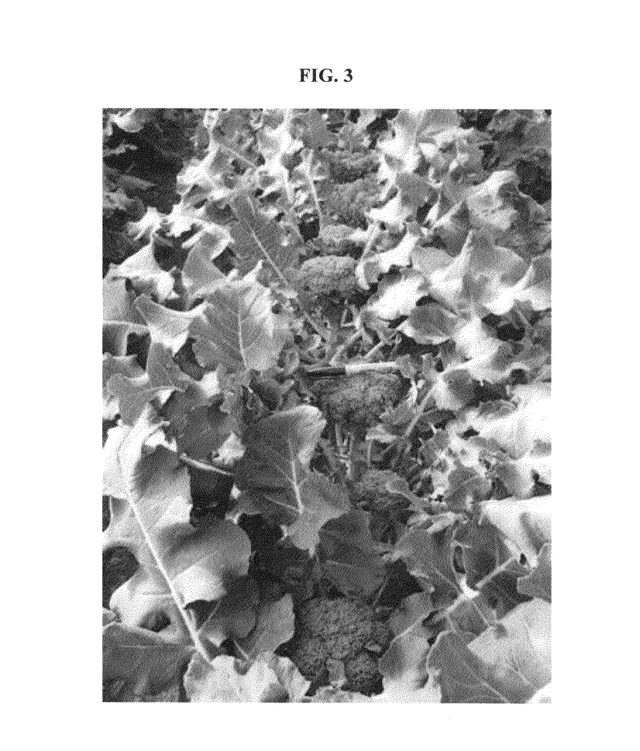

FIG. 4. A close-up side-top view perspective of a row of several, whole ‘Hopkins’ broccoli plants grown in the field, at about fresh market stage maturity.

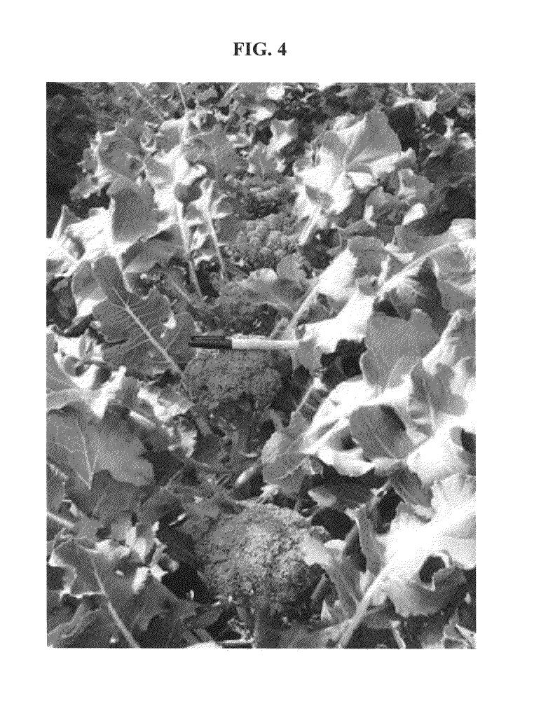

FIG. 5. A chromatograph profile of the glucosinolates from an extract from a typical ‘Hopkins’ selection analyzed by HILIC HPLC.

FIG. 6. A chromatograph profile of the glucosinolates from an extract from a typical ‘Hopkins’ selection analyzed by CIs Reverse-Phase HPLC.

### DETAILED DESCRIPTION OF THE INVENTION

All references cited herein are incorporated in their entirety by reference.

### 1. DEFINITIONS

In the description and tables which follow, a number of terms are used. In order to provide a clear and consistent understanding of the present invention, the following definitions are provided:

A chemoprotector or chemoprotectant is a synthetic or naturally occurring chemical agent that reduces susceptibility in a mammal to the toxic and neoplastic effects of carcinogens.

A cultivar or variety, is a group of similar plants which belong to the same species and which by structural features and performance may be distinguished from other varieties within the same species. Two essential characteristics of a variety are identity and reproducibility. Identity is necessary so that the variety may be recognized and distinguished from other varieties within the crop species. The distinguishing features may be morphological characteristics, color markings, physiological functions, disease reaction, or performance. Most agricultural varieties are pure for those characteristics which identify the variety. Reproducibility is needed so that the characteristics by which the variety is identified will be reproduced in the progeny. A variety is derived from a strain; populations which are increased from a single genotype or a mixture of genotypes are referred to as strains, experimental strains, or lines. Once a strain is identified as superior, it may be named, increased, and made available commercially as a “cultivated variety” or “cultivar.” The words “variety” and “cultivar” are used interchangeably, although cultivar is commonly used in scientific literature while variety is the term used by U.S. farmers and the seed trade.

A cruciferous sprout is a plant or seedling that is at an early stage of development following seed germination. Cruciferous seeds are placed in an environment in which they germinate and grow. The cruciferous sprouts of the instant invention are harvested following seed germination through and including the 2-leaf, 4-leaf, 6-leaf and 8-leaf stage. A sprout is suitable for human consumption if it does not have non-edible substrate such as soil attached or clinging to it. Typically the sprouts are grown on a non-nutritive solid support, such as agar, paper towel, blotting paper, Vermiculite, Perlite, etc., with water and light supplied. If a sprout is not grown in soil, but on a solid support, it does not need to be washed to remove non-edible soil. If a sprout is grown in a particulate solid support, such as soil, Vermiculite, or Perlite, washing may be required to achieve a sprout suitable for human consumption.

An epithiospecifier protein (ESP) is a protein that catalyses formation of nitriles or epithionitriles during glucosinolate hydrolysis by myrosinase. After myrosinase hydrolysis, epithionitriles can be generated by the ESP protein in the presence of iron and a favorable pH; however, in the absence of ESP, glucosinolates convert to isothiocyanates. Heating of a plant material, such as broccoli, for 10 minutes at 140° F., kills the ESP protein while not affecting the enzymatic activity of myrosinase, in turn, maximizing the conversion of glucosinolate to its cognate isothiocyanate (Jeffrey et al. Maximizing the Anti-Cancer Power of Broccoli. Science Daily, p. 1, (2005), Kliebenstein et al. Current Opinion in Plant Biology, 8:264-271 (2005) and Matusheski et al., Phytochemistry, May, 65(9):1273-81 (2004).

A food or drink product, supplement or additive is any ingestible preparation containing the seeds, sprouts, plant parts or whole plants of the instant invention, or extracts or preparations made from these seeds, sprouts, plant parts or whole plants which are capable of delivering Phase 2 inducers to the mammal ingesting the food or drink product, supplement or additive from the group consisting of juices, smoothies, shakes, teas, soups, sauces, salads, granolas, cereals, breads, other baked goods, fried goods, pills and tablets, sprays or other ingestible products, supplements and additives. The food or drink product, supplement or additive can be freshly prepared such as salads, drinks or sandwiches containing seeds, sprouts or other plant parts of the instant invention. Alternatively, the food or drink product, supplement or additive containing seeds, sprouts or other plant parts of the instant invention can be dried, cooked, boiled, lyophilized or baked. Furthermore, extracts of the plant parts or the whole plant can be made and the extracts containing glucosinolates are incorporated into a food or drink product, supplement or additive.

Glucosinolates, which are well known in the art, and are phytochemicals which occur in all plant tissues and degrade via enzymatic hydrolysis. Glucosinolates are grouped as either aliphatic, aromatic, or indole forms. Enzymatic hydrolysis of glucosinolates yields nitriles, epithionitriles, thiocyanates, and/or isothiocyanates depending on the parent glucosinolate, pH and other factors. Examples of glucosinolates include, but are not limited to, glucoraphanin, glucoerysolin, glucoerucin, glucoiberin, glucoalyssin, glucoberteroin, glucoiberverin, glucocheirolin, glucoraphenin, 5-methylsulfinylpentyl glucosinolate, 6-methylsulfinylhexyl glucosinolate, 7-methylsulfinylheptyl glucosinolate, 8-methylsulfinyloctyl glucosinolate, 9-methylsulfinylnonyl glucosinolate, 10-methylsulfinyldecyl glucosinolate, phenylethyl glucosinolate, 4-(α-L-rhamnopyranosyloxy)benzyl glucosinolate, 3-(α-L-rhamnopyranosyloxy)benzyl glucosinolate, 2-(α-L-rhamnopyranosyloxy)benzyl glucosinolate, 4-(4′-O-acetyl-α-L-rhamnopyranosyloxy)benzyl glucosinolate as well as those reviewed in Table 1 of Fahey et al., Phytochemistry, 56:5-51 (2001).

Head diameter is measured at the widest diameter of the head (from overhead) in centimeters at optimum market stage.

Head depth is measured in centimeters from the top of the head to the lowermost florets.

Head height is measured in centimeters from the soil line to the top of the head.

An inbred or breeding line is a plant line which is homozygous, or nearly so. Typically, such lines were produced by conventional plant breeding techniques; however, more recently such lines may be obtained through tissue culture techniques such as doubled haploid production. Inbred lines are used for producing hybrids.

An increased glucosinolate concentration means that the average amount of glucosinolate produced per gram of selected plant tissue or plant part is increased compared to one or both original parents from which the variety was derived.

Inducer activity or Phase 2 enzyme-inducing activity is a measure of the ability of a compound(s) to induce Phase 2 enzyme activity. (Prochaska et al., Anal. Biol chem., 169:328-336 (1988); and Prochaska et al., 1992).

Inducer potential or Phase 2 enzyme-inducing potential is a measure of the combined amounts of inducer activity in plant tissue provided by isothiocyanates, plus glucosinolates that can be converted by myrosinase to isothiocyanates. Glucosinolates are not themselves direct inducers of mammalian Phase 2 enzymes; instead, their metabolic products, isothiocyanates, are inducers. Inducer potential therefore is defined herein as QR activity in murine 1c1c7 hepatoma cells incubated with myrosinase-treated extracts of the seeds, sprouts or other plant parts.

Isothiocyanates are released through enzymatic hydrolysis of glucosinolates by myrosinase. Isothiocyanates are compounds containing the thiocyanate (SCN) moiety and are easily identifiable by one of ordinary skill in the art. The description and preparation of isothiocyanate analogs is described in United States Reissue Patent 36,784, and is hereby incorporated by reference in its entirety. An example of an isothiocyanate includes, but is not limited to, sulforaphane (4-methylsulfinylbutyl isothiocyanate or (−)-1-isothiocyanato-4(R)-(methylsulfinyl) butane) or its analogs.

Leaf width is measured in centimeters at the midpoint of the plant including the petiole.

Leaf length is measured in centimeters from the midpoint of the plant including the petiole.

Maturity is when plants are considered mature when the head and stem have developed to the fresh market maturity stage.

A monofunctional inducer increases the activity of Phase 2 enzymes selectively without significantly altering Phase 1 enzyme activities. Monofunctional inducers do not depend on a functional Ah receptor but enhance transcription of Phase 2 enzymes by means of an Antioxidant Responsive Element (ARE). Sulforaphane is a monofunctional inducer.

Plant height is measured in centimeters from the soil line to the top of the leaves.

Plant material is defined as plant tissue, whole plants, and plant parts consisting of seeds, fruit, sprouts, leaves, stems, tubers, flowers and roots.

Rogueing is the process in broccoli seed production where undesired plants are removed from a variety because they differ phenotypically from the general, desired expressed characteristics of the new variety.

Yield is the weight of seeds harvested per pound per acre.

### 2. GLUCOSINOLATES AND CANCER

It is widely recognized that diet plays a large role in controlling the risk of developing cancers and that increased consumption of fruits and vegetables reduces cancer incidence in humans. It is now believed that a major mechanism of protection depends on the presence of chemical compounds in plants that, when delivered to mammalian cells, elevate levels of Phase 2 enzymes that detoxify carcinogens.

Phase 2 enzymes are effective by detoxifying electrophilic forms of carcinogens which would otherwise damage DNA. Compounds which elevate the level of Phase 2 enzymes are termed “selective inducers.” Monofunctional inducers are selective inducers which only induce Phase 2 enzymes without significantly inducing Phase 1 enzyme activities. Monofunctional inducers are nearly all electrophiles and belong to at least 9 distinct chemical classes. (Prestera et al., Proc. Natl. Acad. Sci. USA, 90: 2963-2969 (1993) and Khachick et al., In Antioxidant Food Supplements in Human Health, Packer, L. et al. (eds), San Diego: Academic Press, pp. 203-229 (1999)). Compounds which induce both Phase 2 and Phase 1 enzymes are designated bifunctional inducers. (Prochaska et al. (1988) Cancer Research 48:4776-4782). The only apparent common property, shared by almost all of these inducers is their ability to react with thiol groups.

Monofunctional inducers are thus chemoprotective agents which reduce the susceptibility of mammals to the toxic and neoplastic effects of carcinogens due to their ability to induce only Phase 2 enzymes. Chemoprotectors can be of plant origin or synthetic compounds. Synthetic analogs of naturally occurring inducers have been generated and have shown to block chemical carcinogenesis in animals. (Posner et al., 1994; Zhang et al., Proc. Natl. Acad. Sci. USA, 91: 3147-50 (1994); and Zhang et al., Cancer Research, (Suppl) 54: 1976s-1981s (1994)).

It is now known that most of the inducer activity of crucifer plants is due to the presence and amounts of isothiocyanates and their biogenic precursors, glucosinolates. Glucosinolates are converted to isothiocyanates by the enzyme myrosinase, which is a thioglucoside glucohydrolase. Normally, myrosinase and glucosinolates are separated in the cell. If the cell is damaged, resulting in disruption of cellular compartmentalization, myrosinase comes into contact with glucosinolates, and converts them to isothiocyanates. Although glucosinolates are not themselves inducers of mammalian Phase 2 enzymes, their conversion products, by virtue of myrosinase activity, are. Thus, it is the isothiocyanate products which are potent monofunctional inducers of Phase 2 enzymes.

However, not all glucosinolates produce isothiocyanates which are inducers of Phase 2 enzymes. Certain glucosinolates (e.g. alkylthioalkyl glucosinolates) produce isothiocyanates that are potent chemoprotective agents. Other glucosinolates (e.g. indole glucosinolates) produce compounds, such as indole-3-carbinol and indole-3-acetonitrile, that are problematic for several reasons. First, such indole glucosinolates are bifunctional inducers; that is, they induce both Phase 1 and Phase 2 enzymes. Phase 1 enzymes can activate xenobiotics thereby creating carcinogens. (Prochaska & Talalay, Cancer Research, 48: 4776-4782 (1988)). Second, the indole glucosinolates are only weak inducers of Phase 2 enzymes (Fahey et al., Chapter 2 in Functional Foods for Disease Prevention, I. Shibamoto T. et al. (eds), ACS Symposium Series 701, Washington D.C.: Am. Chem. Soc., pp. 16-22 (1998)). Third, these compounds themselves can function as tumor promoters (Kim et al., Carcinogenesis, 18(2):377-381 (1997)). Finally, these compounds can form condensation products under the acid conditions encountered in the stomach, which are potent carcinogens very similar to dioxin (TCDD) (Bjeldanes et al., Proc. Nat. Acad. Sci. USA, 88:9543-9547 (1991)).

Thus, the amounts of inducer activity depends upon both the quality and quantity of glucosinolates present in crucifer plants. Market stage broccoli and cauliflower, for example, contain among the highest levels of the alkylthioalkyl glucosinolates, 4-methylsulfinylbutyl and 3-methylsulfinylpropyl glucosinolate identified in vegetables. They also contain levels of the indole glucosinolates, glucobrassicin (indolyl-3-methyl glucosinolate), neoglucobrassicin, and 4-hydroxyglucobrassicin. Further, broccoli and cauliflower germinated seeds, sprouts, and young plantlets contain higher concentrations of glucosinolates than do market stage vegetables.

The amount of glucosinolates present in cruciferous sprouts may depend to some extent upon the leakage of glucosinolates from the seeds upon imbibition and germination. The processes of seed imbibition and germination, as well as priming, osmoconditioning, matri-conditioning and the like, though primarily associated with a net influx of water to the seed and seedling, also typically involve the leaking or leaching of chemicals from the germinating seed. The amount of chemicals leaking from the seed can be regulated by the milieu in which the seed is placed, although some leakage is inevitable. Furthermore, the amount of leakage may also be related to the quality of the seed lot, and to the type of seed.

The leachates of cruciferous seeds can exhibit potent antibiotic activity. This activity is effective not only against a range of human pathogens, but also against other microbes which commonly thrive or co-exist in commercial green sprout (such as bean sprout or green leafy sprout) production systems, which thus effectively contaminate these systems. For example, while the leachates of alfalfa seed, the primary raw material of the green sprouts industry, actually stimulate the growth of Escherichia coli, leachates of cruciferous seeds contain glucosinolates and their isothiocyanate congeners which inhibit the growth of E. coli. The antibiotic activity of germinating crucifer seeds, in both the seeds and seedlings and the leachate resulting therefrom, is related to the glucosinolate content of the seed. Thus, glucoraphanin and its isothiocyanate congener, sulforaphane, are not only chemoprotective (by inducing Phase 2 enzymes of xenobiotic detoxification in mammals), but they are also antimicrobial.

### 3. PLANT SELECTION

Preferably, plants selected for screening are those with desirable agronomic characteristics. However, if less desirable plants are selected for screening, the trait of a desirable glucosinolate profile can be introduced into commercially desirable varieties by conventional breeding techniques.

It is also preferred that plants selected for screening be grown under similar conditions and be harvested at similar stages of development. This facilitates comparison among different individual plants, as both the quantity and quality of glucosinolates is known to vary among different plant tissues and at different stages of development, and to vary upon different growing conditions. The parts of the plants selected for screening include seeds, sprouts, and florets. The tissue chosen depends upon the ultimate market for which the germplasm is being developed. Depending upon the choice of tissue for screening, different individual plants may be selected, as the glucosinolate profile in each tissue may vary within one plant, and there appears to be no correlation among the different tissue profiles. For example, a plant with a market stage head tissue which possesses a desirable glucosinolate profile may have a sprout with an undesirable, or less desirable, glucosinolate profile, or has a total levels of alkylthioalkyl glucosinolates that are very low compared to other cultivars.

Plants are selected that exhibit a desirable glucosinolate level in the appropriate plant tissue for the end market, such as seeds, sprouts, or extracts therefrom. Preferably, the glucosinolate level in the market stage plant part is higher than one or more of the parents. Preferably the glucosinolate level is 1%, 5%, 10%, 15%, 20%, 25%, 30%, 35%, 40%, 45%, 50%, 55%, 60%, 65%, 70%, 75%, 80%, 85%, 90%, 95%, 100% or some integer in between higher than one or both of the parents when expressed as micromoles per gram at market stage plant tissue.

### 4. PLANT BREEDING

Once individual plants possessing a desirable glucosinolate concentration in the end market stage plant parts are selected, they are used for further development. The increased glucosinolate concentration may occur in market stage heads, sprouts, seeds, or other plant parts. The following breeding procedures may be applied to plants which are doubled haploids, mutagenized plants, or other source plants screened for glucosinolate profiles.

In general, breeding is effected by screening progeny of the selected plants for the trait of increased glucosinolate concentration where the concentration is produced in the desired plant parts at the desired plant developmental stages. Plants carrying this trait are further developed by intensifying the trait or by combining the trait with other important agronomic characteristics. Thus, plants with the selected trait may be used directly to establish new varieties, or they may be used as a source to transfer the trait into other agronomically desirable varieties.

The goal of the breeding program is to ensure that the selected glucosinolate concentration is stable, that it exists in plants with desirable agronomic characteristics or can be transferred into such plants, and that the selected plants can be used to develop varieties or lines from which marketable hybrid seed can be created.

In general, there are two types of possible stable varieties in broccoli, one being an inbred or homozygous line and the other being a hybrid or heterozygote that is formed by crossing two inbreds. Most standard broccoli varieties grown for vegetable production are hybrids. The breeding cycle that results in hybrids is a series of generations wherein a breeder selects the plants with the best combination of characteristics among segregating individuals, and then selfs those selections, repeating this process over and over for several generations of selection and selfing. Once the select inbreds are stable, the breeder crosses the inbreds with others to make stable hybrids that are then tested in the field. After several rounds of testing, hybrids are discarded or retested and finally chosen as an improved hybrid that can be sold as a commercial variety. Any hybrid chosen as a variety must be typically regenerated every year by re-crossing the inbred parents.

Although broccoli inbreds are not typically grown as varieties, it is feasible to do this. Work leading up to the development of ‘Hopkins’ and cited in this patent has provided evidence that inbreds can be vigorous and productive, especially when it comes to seed production. To develop an inbred as a variety, it is only necessary to conduct the first part of the process, the inbreeding and selection part, used to develop hybrids. One skilled in the art starts with a segregating population from which to make selections, and must go through several generations of identifying the best individuals and advance them by selfing. Once these select inbreds are stable, they are then directly tested in production using some check variety or varieties for comparison. If deemed to exhibit improved characteristics, they could be commercialized relatively easily.

Unique to the development of ‘Hopkins’ is the additional aspect of selecting individuals that are highly self compatible at the same time one selects the best individuals with good horticultural and agronomic traits to advance to the next cycle of inbeeding. This is simply done by conducting all selections in environments (e.g., cages or greenhouses) where insect pollinators are not present. The end product of this total scheme is a highly inbred (homozygous) variety that produces a consistent seed yield, that is stable, and that is easily reproduced or regenerated without the need for insect pollinations.

### 5. SCREENING: GLUCOSINOLATE CONCENTRATION

A major mechanism of protection provided by crucifer plants, including broccoli plants, in reducing the incidence of cancer in humans depends on the presence in the plant tissue of glucosinolates which, when delivered to mammalian cells, elevate levels of Phase 2 enzymes that detoxify carcinogens. It has now been discovered that the anticarcinogenic activity of crucifer plants can be increased by developing novel inbred lines with enhanced chemoprotectant activity. The enhanced chemoprotectant activity is due to an enhanced alkyl to indole glucosinolate ratio. Such an enhanced ratio can be achieved, for example, by a quantitative increase in the level of specific alkyl glucosinolates, such as alkylthioalkyl glucosinolates, or by a quantitative decrease in the level of indole glucosinolates. The chemoprotectant activity of market sprout tissue may also be enhanced by developing novel inbred crucifer lines which produce seeds with decreased leakage of seed material.

The tissue sampled for glucosinolate content depends upon the objectives of the breeding program. The sampled tissue may include market stage heads (which are flower buds before they open), leaf tissue, seed tissue, and/or sprout tissue. When breeding for a desirable glucosinolate profile in market stage heads, the flower bud tissue is preferably sampled before the buds have opened.

In order to screen large numbers of individual plants to select those plants with an increased glucosinolate concentration, it was necessary to develop improved techniques for isolating, identifying, and quantitating the different types of glucosinolates present in the plant extracts.

In general, plant extracts are prepared by homogenizing plant tissue. Solvents used to extract glucoraphanin include boiling methanol, boiling water, ice-cold water, and acetonitrile. Plant extracts may be prepared by immersing harvested plant tissue in boiling water, followed after a short period of time by homogenization, or the plant extracts may first be ground and then added to boiling water prior to homogenization. In all cases, the homogenates are centrifuged, and the supernatant is optionally filtered to remove remaining particulates. The resulting crude aqueous extract may be stored at −20 to −80° C. until it is analyzed. Intact glucosinolates from the crude plant extracts are then isolated, identified, and quantitated by sequential analysis.

Separation of individual glucosinolates is difficult because these molecules are highly charged and water-soluble; resolution of the different molecules depends on the properties of the less polar side chains. Many less than ideal chromatographic methods have been developed for the isolation and separation of glucosinolates. (Betz and Fox, In Food Phytochemicals for Cancer Prevention. I. Fruits and Vegetables, Huang, et al. (eds), ACS Symposium Series, Washington, D.C.: Am. Chem. Soc., 546, pp 181-196 (1994); Heaney and Fenwick, In Glucosinolates in Rapeseeds: Analytical Aspects, Wathelet, J P (ed), The Netherlands: Nijhoff Dordrecht, pp 177-91 (1987); Wathelet, J. P. In Glucosinolates in Rapeseeds: Analytical Aspects, Wathelet, J P (ed), The Netherlands: Nijhoff Dordrecht (1987)).

Prior to 1996, preliminary analytical methods for the analysis of glucosinolates included ion exchange, gas liquid chromatography (GLC) and Hydrophilic Interaction Liquid Chromatography (Prestera, 1996) In 1996, Prestera et al. published a method which included reverse-phase paired ion chromatography (PIC) of the hydrophobic tetraakylammonium salts of the glucosinolates in the presence of an excess of these counterions, conversions of the glucosinolate salts to their ammonium salts, direct negative-ion fast atom bombardment (FAB) spectroscopic and ammonia chemical ionization (CI) mass spectroscopic analysis, and finally high resolution nuclear magnetic resolution (3H NMR) spectroscopy. The procedure of Prestera, et al. (1996) offered a simple and direct strategy for analyzing the glucosinolate content of plant extracts and provided a powerful technique for identification and quantification of glucosinolates in plant extracts without resorting to derivation.

Procedures for the sequential analysis of glucosinolates continue to be modified in order to more accurately determine the glucosinolate content of plant materials. In particular, over the last decade, new High Performance Liquid Chromatography (HPLC) methods have been developed to analyze glucosinolates in plant materials (Bennett et al., J. Agric. & Food Chem., 52:428-438 (2004) and West et al., J. Agric. & Food Chem., 2004).

HPLC is the analytical process used for separation, purification, identification and quantification of organic compounds in a sample. In the first step of separation, compounds in the sample have different migration rates dependent on the column and mobile phase selected. The second step of purification focuses on separating and/or extracting the target compound from other possibly related compounds. Accordingly, the extent or degree of the separation and purification of the compounds varies by the choice of stationary and mobile phase. Different types of stationary phases include: liquid-liquid, liquid-solid (also known as adsorption), size exclusion, normal phase, reverse phase, ion exchange and affinity and different types of mobile phases include isocratic, gradient and polytyptic. After separation, various columns can be used which include: guard, derivatizing, capillary, fast and preparatory. The crucial step of identification of compounds may vary by the detection method selected (Refractive-Index (RI), Ultra-Violet (UV), Fluorescent, Radiochemical, Electrochemical, Near-Infra Red (Near IR), Mass-Spectroscopy (MS), Nuclear Magnetic Resonance (NMR) and Light Scattering (LS)) and the development of the separation assay. Identification of compounds is often verified by combining at least two detection methods. Quantification of the compounds is determined by comparison of the peaks produced by HPLC of the known concentration of the standard compound to the concentration of the injected compounds. The resulting data can then be generated for review using computer software programs.

As referenced above, there are several variables and combinations which can be modified by a researcher when using the analytical method of High Performance Liquid Chromatography. Accordingly, researchers often continue to modify HPLC methods after review of newly published research results, updated manufacturer's Standard Operating Procedures, and research trial and error.

In this invention, two different High Performance Liquid Chromatography (HPLC) methods have been used to identify and quantify the glucoraphanin content of seeds of ‘Hopkins’: Hydrophilic Interaction Chromatography (HILIC) (Troyer et al., J. Chromatogr., 919:299-304 (2001)) and C₁₈ Reverse-Phase (Bennett et al., J. Agric. Food Chem., 52:428-438 (2004) and West et al., 2005).

Hydrophilic Interaction Chromatography (HILIC) method is an advantageous HPLC method since it can separate glucosinolates, hydrophilic by nature, by eluting a hydrophobic or mostly organic mobile phase across a neutral hydrophilic stationary phase. Glucosinolates will elute in the order of increasing hydrophilicity. HILIC does not require desulfaction for separation and can operate in a broad pH range, which in turn, may improve the retention and intact selection of glucosinolates. HILIC also allows for direct LC-MS analysis (Troyer et al., 2004).

C₁₈ Reverse-Phase HPLC method for testing intact glucosinolates has become a preferable method since it believed to provide a more accurate determination of glucosinolate content (Bennett et al., 2004 and West et al., 2005). C₁₈ Reverse-Phase HPLC allows for better separation of glucoraphanin from structurally similar alkyl glucosinolates, which in turn, provides improved resolution for calculation of the curve value (West et al., 2005). Further, the reversed polarity, shorter elution time and well-defined base separation and peak attributes of C₁₈ Reverse-Phase HPLC have been claimed to provide a better recovery of the true amount of glucoraphanin contained per plant part (Bennett, 2004).

### 7. GLUCOSINOLATES AND FOOD OR DRINK PRODUCTS, SUPPLEMENTS OR ADDITIVES

The present invention relates generally to a dietary approach to reducing the levels of carcinogens in mammals and their cells, and thereby, reducing the risk of developing cancer. In particular, this invention relates to the production and consumption of food or drink products, supplements or additives which are rich in cancer chemoprotective compounds. Thus, this invention relates to selecting and scientifically breeding broccoli plants with consistent, enhanced chemoprotective compounds which can be processed and incorporated into food or drink products, supplements or additives.

While breeding efforts initially focused on selectively breeding new broccoli heads, research studies have indicated that broccoli seed and seedling sprouts contain glucoraphanin concentrations up to ten times as great as the glucoraphanin concentration found in mature broccoli heads (Brooks et al., 2001; and Fahey and Talalay, Food Chem. Toxicol., 37:973-79 (1999)). Accordingly, breeding efforts have expanded to include selective breeding programs to produce new broccoli varieties which have the ability to produce seeds and broccoli sprouts with consistent, increased glucoraphanin content to enhance their chemoprotective potency.

Use of the isothiocyanate sulforaphane as a pharmaceutical or food supplement is covered by U.S. Pat. No. 5,411,986, and use of certain cruciferous seeds and seed products, including sprouts, as a food product high in or as a source of glucosinolates and isothiocyanates, including glucoraphanin and sulforaphane, is covered by U.S. Pat. No. 5,725,895.

If fresh-picked vegetables are promptly and gently harvested, directly into organic solvents, comprising a mixture of DMF/ACN/DMSO and a temperature that prevents myrosinase activity, both glucosinolates and isothiocyanates are efficiently extracted into the organic solvent mixture. Preferably, the DMF, ACN and DMSO are mixed in equal volumes. However, the volumes of the three solvents in the mixture can be varied to optimize extraction of specific glucosinolates and isothiocyanates from any plant tissue. The temperature of the extraction mixture is preferably less than 0° C., and most preferably less than −50° C. The temperature of the extraction solvent must be kept above freezing. At the same time the enzyme myrosinase, which invariably accompanies these constituents in the plants and rapidly converts glucosinolates into isothiocyanates, is inactive. Such extracts typically contain high quantities of glucosinolates and negligible quantities of isothiocyanates. The in planta myrosinase activity varies between different plant species.

Glucosinolates are converted at least partially to isothiocyanates in humans. If, however, it is desirable to accelerate this conversion, broccoli or other vegetable sprouts, high in glucosinolates, can be mixed with myrosinase. The mixture can be in water, or some other non-toxic solvent that does not inactivate myrosinase. The myrosinase can be from a partially purified or purified preparation. Alternatively, the myrosinase can be present in plant tissue, such as a small quantity of crucifer sprouts rich in myrosinase. Such a preparation can be used to produce a “soup” for ingestion that is high in isothiocyanates and low in glucosinolates.

Non-toxic solvent extracts according to the invention are useful as healthful infusions or soups. Sprouts can be extracted with cold, warm, or preferably hot or boiling water which denature or inactivate myrosinase. The residue of the sprouts, post-extraction, may or may not be removed from the extract. The extraction procedure may be used to inactivate myrosinase present in the sprouts. This may contribute to the stability of the inducer potential. The extract can be ingested directly, or can be further treated. It can, for example, be evaporated to yield a dried extracted product. It can be cooled, frozen, or freeze-dried. It can be mixed with a crucifer vegetable which contains an active myrosinase enzyme. This will accomplish a rapid conversion of the glucosinolates to isothiocyanates, prior to ingestion.

The inducer potential, as distinct from inducer activity, of plant extracts can be measured by adding purified myrosinase, obtained from the same, or other plant sources, to an assay system. Inducer potential can be measured using a multiwell plate screen with murine hepatoma cells for in vitro measurement of QR specific activity.

Seeds, as well as sprouts have been found to be extremely rich in inducer potential. Thus, it is within the scope of the invention to use crucifer seeds in food or drink products, supplements or additives. Suitable crucifer seeds may be ground into a flour or meal for use as a food or drink product, supplement or additive. The flour or meal is incorporated into breads, other baked goods, or health drinks or shakes. Alternatively, the seeds may be extracted with a non-toxic solvent to prepare soups, teas or other drinks and infusions. The seeds can also be incorporated into a food product without grinding. The seeds can be used in many different foods such as salads, granolas, breads and other baked goods, among others.

Glucosinolates and/or isothiocyanates can be purified from seed or plant extracts by methods well known in the art. (Fenwick et al., CRC Crit. Rez. Food Sci. Nutr., 18: 123-201 (1983); Zhang et al., Pro. Natl Acad. Sci. USA, 89: 2399-2403 (1992); Bennett et al., J. Agric. & Food Chem., 52:428-438 (2004) and West et al., J. Agric. & Food Chem., 2004) Purified or partially purified glucosinolate(s) or isothiocyanate(s) can be added to food or drink products as a supplement or additive. The dose of glucosinolate and/or isothiocyanate added to the food product preferably is in the range of 1 μmol to 1,000 μmols. However, the dose of glucosinolate and/or isothiocyanate supplementing the food or drink product can be higher.

Thus, food or drink products, supplements or additives of the instant invention may include seeds, sprouts or other plant parts, as well as, extracts of seeds, sprouts or other plant parts taken from the new broccoli variety ‘Hopkins’.

It has been found that genetically distinct crucifers produce chemically distinct Phase 2 enzyme-inducers. Different Phase 2 enzyme-inducers detoxify chemically distinct carcinogens at different rates. Accordingly, food or drink products, supplements or additives composed of genetically distinct crucifer sprouts or seeds, or extracts or preparations made from these sprouts or seeds, will detoxify a broader range of carcinogens.

### 8. EXAMPLES

### Example 1

### Breeding of ‘Hopkins’

The initial steps in selecting this new broccoli variety ‘Hopkins’ were done in Baltimore, Md. in 1997-2001. Subsequent and final steps in developing the variety were completed at several California test sites using cages and pilot field plots in 2001-2004. All tests to determine the glucoraphanin concentration of seed lots generated in the development process were conducted in both Baltimore, Md., and at the U.S. Vegetable Lab (USVL) in Charleston, S.C., in 1997 through 2001. After 2001, tests to determine the glucoraphanin concentration of developed seed lots were conducted in Baltimore, Md.

‘Hopkins’ was developed as a self-compatible variety that does not require pollination by insects and that produces consistent yields of seed which consistently contain greater than 60 μmole of glucoraphanin per gram of seed (with an average range of 68-85 μmole of glucoraphanin per gram of seed) when analyzed by Hydrophilic Interaction Liquid Chromatography (HILIC) and greater than 80 μmole of glucoraphanin per gram of seed (with an average range of 85-105 μmole of glucoraphanin per gram of seed) when analyzed by CIs Reverse-Phase HPLC under ideal growing conditions. Thus, ‘Hopkins’ was primarily developed for the production of high quality broccoli seed well suited for making broccoli seedling sprouts with high glucoraphanin content and high chemoprotective value. In addition, ‘Hopkins’ was developed to produce seeds and sprouts that can be used as a source of high glucoraphanin concentration. The seeds, sprouts, or other plant parts can be directly incorporated into food, drinks, pills, additives, supplements or other ingestible materials. Alternatively, powders or flour made from these same plant parts can be incorporated into food, drinks, pills, additives, supplements or other ingestible materials. In addition, extracts can be made from these same seeds, sprouts or other plant parts, and these extractions can be incorporated into food, drinks, pills, additives, supplements or other ingestible materials.

‘Hopkins’ is an inbred line of broccoli derived from a heterogeneous and heterozygous open-pollinated population of ‘Italian Green Sprouting’ broccoli. ‘Italian green sprouting’ broccoli is a generic broccoli akin to an old landrace of this crop. No two plants in an ‘Italian Green Sprouting’ population are alike, and typically, neither are any two samples of this variety obtained from different sources.

In the winter of 1997-1998, a population of ‘Italian Green Sprouting’ broccoli was grown out in a greenhouse at the USVL in Charleston, S.C. A few unique individuals in the population were identified that set seed in the absence of insect pollinators. With no pollinators present, any seed produced in the USVL greenhouses resulted due to selfing. Selfed seed was harvested from selected plants, and the selection process was repeated for the next three winters through the winter of 2000-2001 in Charleston, S.C.

Advancement in all years was based on selection for individual plant yield as measured by seed weight per plant. After four generations of selfing and advancement of individual plants, the progenitor of ‘Hopkins’ was a homogeneous breeding line producing very uniform progeny and consistently high seed yields in greenhouse and field cage tests. Assessment of glucoraphanin concentration of seed showed it to be greater than 60 μmole of glucoraphanin per gram of seed (with an average range of 68-85 μmole of glucoraphanin per gram of seed) when analyzed by Hydrophilic Interaction Liquid Chromatography (HILIC) and greater than 80 μmole of glucoraphanin per gram of seed (with an average range of 85-105 μmole of glucoraphanin per gram of seed) when analyzed by C₁₈ Reverse-Phase HPLC.

From 2001-2004, the ‘Hopkins’ progenitor was advanced in screen cages (free of insect pollinators) in Arroyo Grande, Calif. In all of these cage trials, the breeding line was rogued of all off-types. In addition, any individual plant that exhibited susceptibility to white mold, caused by the fungi Sclerotinia, was removed. These final exclusions of off-types and diseased plants resulted in a selected line with a very high degree of uniformity and less susceptibility to white mold. This line was designated as ‘Hopkins’.

Seeds of the new broccoli variety ‘Hopkins’ were deposited in the American Type Culture Collection (ATCC), P.O. Box 1549, Manassas, Va. 20108, U.S.A., and accorded ATCC deposit accession number PTA-6945. 2500 seeds were deposited with the ATCC on Aug. 17, 2005.

### Example 2

### Materials & Methods for Glucoraphanin Analysis of Seeds of ‘Hopkins’

### 1. Plant Materials and Chemicals

Seeds obtained were from the 2001-2006 growing seasons in Arroyo, Calif. All solvents were of ACS or HPLC grade, water was deionized or of HPLC grade, and chemicals were of analytical grade. Sinigrin (Sinigrin Monohydrate (98%) ACROS catalog #13271-0110 or Sigma catalog #S1647-IG) and Glucoraphanin (obtained from C2 BIOENGINEERING, Hovedgaden 12, DK-2690 Karlslunde, DENMARK)) were used as standards.

### 2. Extraction

Prior to extraction, seed moisture is determined according to the International Rules for Seed Testing, and the seeds are heated.

Extraction solvents can include 1) boiling water, 2) QuadSolvent (equal parts of Methyl Sulfoxide (DMSO), Dimethylformamide (DMF), Acetonitrile, and deionized water) or 3) “Tri-Solvent+1” (Tri-Solvent: equal parts of Methyl Sulfoxide (DMSO), Dimethlyformamide (DMF) and Acetonitrile) and (+1 is deionized or HPLC grade water).

a. Extraction by Boiling Water or QuadSolvent:

Add 20 ml of either boiling water or QuadSolvent to 1.0 g±0.1 g seed sample in DigiTube and centrifuge using a Brinkman Polytron Homogenizer (Model PT 10 20 3500 or its equivalent) equipped with a PTA-10S generator (Brinkmann cat. No. 027113303) for 3 minutes at a setting of 50% power. If foaming begins, slow speed of centrifuge to minimize foaming.

b. Extraction by “Tri-Solvent+1”:

Add 15 ml of Tri-Solvent to 1.0 g±0.1 g seed sample in DigiTube and homogenize using a Brinkman Polytron Homogenizer (Model PT 10 20 3500 or its equivalent) with a PTA-10S generator (Brinkmann cat. No. 027113303) for 3 minutes at a setting of 50% power. Add 5 mL of deionized or HPLC grade water to DigiTube and homogenize the sample again for 2 minutes at a setting of 50% power. If foaming begins, slow speed of centrifuge to minimize foaming.

After solvent extraction, transfer an aliquot to a 1.5 mL Eppendorf centrifuge tube. Centrifuge to pellet seed debris using a minfuge (VWR Model F micro-centrifuge) for about 2 minutes.

Dilute supernatant using Acetronitrile (1:10 supenatent:acetroniltrile, i.e. 100 ml sample+900 ml acetronitrile) and add to amber crimp top vial and cap. Transfer for HPLC analysis.

### 4. HPLC Analysis

a. Hydrophilic Interaction Chromatography (HILIC)

The glucoraphanin content per gram of seed of the ‘Hopkins’ variety was analyzed using Hydrophilic Interaction Chromatography (HILIC) as described by (Troyer et al., 2001). Inject 100-200 uL onto HILIC. Glucoraphanin was separated using a Polyhydroxyethyl A (3 μM) column (100 mm×4.6 mm, 3 □m, 100□ (PolyLC Inc., Columbia, Md. 410-992-5400, cat no. 104HY0301)) with a flow rate of 2 mL/min at about 20° C. in combination with an Upchurch Scientific precolumn filter (2 μM). Remove column from 4° C. storage and allow to come to room temperature (about 45-60 minutes). Equilibrate column with the mobile phase (30 mM Ammonium Formate, 85% Acetonitrile, pH 5.4) for a flow of 2 ml/min for at least 30 minutes.

During the mobile phase, elution of glucoraphanin from the column was performed by 30 mM Ammonium Formate, 85% Acetonitrile, at a pH 5.4. The total running time was 20 min.

A Diode Array Detector capable of UV/Vis detection was used at a fixed wavelength of 235 nm. The results were analyzed using Empower software, (Waters Corporation, 34 Maple St., Dept. TG, Milford, Mass. 01757). The glucoraphanin concentration value was generated from the Sinigrin and Glucoraphanin standards, and express as μmol/g of seed.

b. C₁₈ Reverse-Phase

The glucoraphanin content per gram of seed of the ‘Hopkins’ variety was analyzed using C₁₈ Reverse-Phase High Performance Liquid Chromatography (HPLC) as described by (Bennett et al., 2004 and West et al., 2004). Glucoraphanin was separated using a Luna C₁₈ (5 μM) reverse-phase column (250 mm×4.6 mm; Phenomenex, (Torrance, Calif., USA) with a flow rate of 1 mL/min at room temperature (about 25° C.) in combination with a Phenomenex SecurityGuard guard column. During the mobile phase, elution of glucoraphanin from the C₁₈ HPLC column was performed by gradient system of Solvent A: 0.1% Trifluoroacetic acid (TFA) in methanol, Solvent B: 0.1% Trifluoroacetic acid (TFA) in water, Solvent C: 50% v/v methanol/water and Solvent D: 50% v/v water/methanol. The total running time was 20 min.

A UV-VIS detector was used at a fixed wavelength of 235 nm. The results were analyzed using Empower software, (Waters Corporation, 34 Maple St., Dept. TG, Milford, Mass. 01757). The glucoraphanin concentration value was generated from the Sinigrin and Glucoraphanin standards, and express as μmol/g of seed.

Table 1 summarizes some of the primary differences between the Hydrophilic Interaction Chromatography and C₁₈ Reverse-Phase HPLC methods used to analyze the glucoraphanin content of seeds of ‘Hopkins’.

TABLE 1

| HPLC Analytical | Hydrophilic Interaction | |
|---|---|---|
| Method | Chromatography | C18 Reverse-Phase |
| Greater than | 60 μmoles/g | 80 μmoles/g |
| Glucoraphanin of | | |
| Seed of ‘Hopkins’ | | |
| Average range of | 68 to 85 μmoles/g | 85 to 105 μmoles/g |
| Glucoraphanin of | | |
| Seed of ‘Hopkins’ | | |
| Elution Times | Sinigrin @ 4.3 minutes | Sinigrin @ 6.2 minutes |
| | Glucoraphanin @ | Glucoraphanin @ 6.5 |
| | 12.8 minutes | minutes |
| HPLC Flow Rate: | 2 ml/min | 1 ml/min |
| Mobile Phase: | 30 mM Ammonium Formate, | 0.1 v/v Trifluoroacetic acid |
| | 85% Acetonitrile (ACN) | (TFA) in H20 & Methanol |

### 5. Calculation of Glucoraphanin Concentration in Seeds

The concentration of glucoraphanin in the seeds of ‘Hopkins’ was determined by the ratio between the metabolite peak areas of the Sinigrin and Glucoraphanin standards. A linear regression curve was produced and the slope of the standard calibration curve was used to produce the glucoraphanin values of ‘Hopkins’

In order to the convert μmoles/g GR from the generated HPLC curve, the following calculation must be completed:

$$\frac{grams of sample}{mL s of extraction solvent} \times \frac{10 µL supernatant}{1 \text{,} 000 µL ACN} \times \\ 0.1 mL sample injected on column = 1 \times 10 - 4 grams sample$$

$$\frac{Curve Value ( µmol )}{1 \times {10}^{- 4} grams ( see above )} = Final Result \text{:} \frac{µmol}{g} GR$$

Please note that the following glucoraphanin calculation is based on 1) the actual weight of sample in grams, 2) the actual mL of extraction volume (in mLs), 3) the μL filtered supernatant added to 1000 μL final volume (dilution factor), and 4) the μL sample injected onto HPLC column (In mLs).

To calculate the GR concentration per μmoles of gram of seed, the following calculation must be completed:

where R=percent recovery

Cs=fortified sample concentration

C=sample background concentration

s=concentration equivalent of analyte added to fortify the sample

$$1 \times \frac{1}{436} \times \frac{1000 µmole}{1} GR \times \frac{1}{1000} \times \frac{1}{0.010} \times \frac{20}{1 g sample} = \begin{matrix}µmole GR \\ g sample\end{matrix}$$

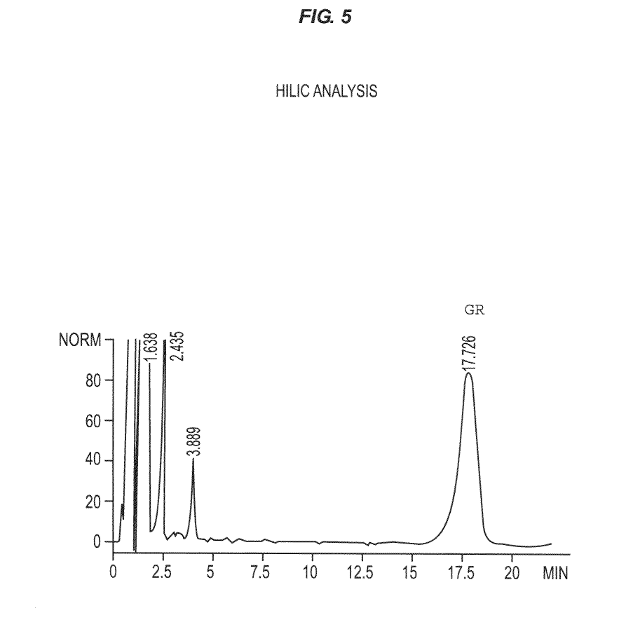

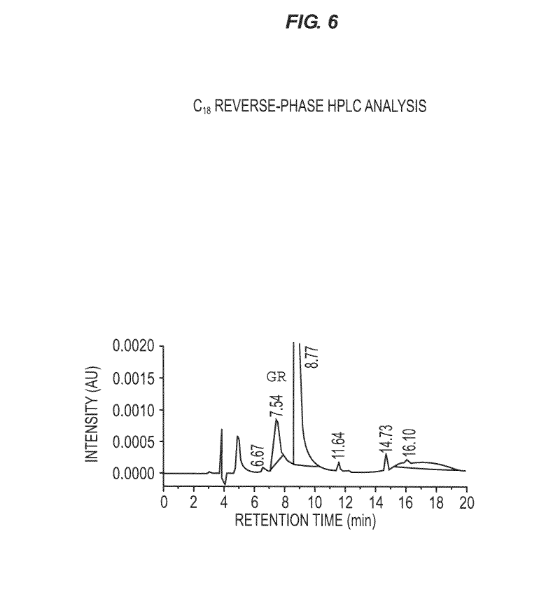

A glucoraphanin calculation based on HILIC analysis of seed of ‘Hopkins’ is shown in FIG. 5 (85 μmole of glucoraphanin per gram of seed). A glucoraphanin calculation based on C₁₈ Reverse-Phase HPLC analysis of seed of ‘Hopkins’ is shown in FIG. 6 (100 μmole of glucoraphanin per gram of seed).

### Example 3

### Glucoraphanin Comparison Data for Broccoli Varieties by HILIC and C₁₈ Reverse-Phase HPLC

The new broccoli variety ‘Hopkins’ was produced primarily to produce consistent yields of seed with consistent, high glucoraphanin levels which are greater than 60 μmole of glucoraphanin per gram of seed (with an average range of 68-85 μmole of glucoraphanin per gram of seed) when analyzed by Hydrophilic Interaction Liquid Chromatography (HILIC) and greater than 80 μmole of glucoraphanin per gram of seed (with an average range of 85-105 μmole of glucoraphanin per gram of seed) when analyzed by C₁₈ Reverse-Phase HPLC.

Seeds of ‘Hopkins’, together with seeds of many inbreds, including precursors of ‘Hopkins’, were initially analyzed for glucoraphanin content using HILIC. Extensive testing using the HILIC method has been completed and compared to analyze the glucoraphanin concentration in seeds of other self pollinated, open pollinated broccoli varieties (Table 2) and broccoli hybrids that are widely used in the U.S. (Table 3) to the new broccoli variety ‘Hopkins’.

TABLE 2
Glucoraphanin Concentration of Seeds of Sampled Self-Pollinated,
Open-Pollinated Broccoli Varieties by HILIC

| Date Sample | Brand/ | GR |
|---|---|---|
| Sent | Variety Name | μmol/g |
| May 12, 1998 | Deccico | 41.5 |
| May 12, 1998 | Calabrese-1 | 39.1 |
| | H&H Field#1 | |
| | Mexico | |
| | green seed | |
| May 12, 1998 | Calabrese-3 | 43.5 |
| | H&H Field #1 | |
| | Mexico | |
| | Broc. Seed | |
| May 12, 1998 | Calabrese-4 | 40.3 |
| | H&H Field #2 | |
| | Mexico | |
| | Broccoli | |
| May 18, 1998 | Slocum@K&F | 42 |
| | Calabrese | |
| May 18, 1998 | K&F 7146 | 28 |
| | Calabrese | |
| | Med. Size | |
| May 18, 1998 | Calabrese-7 | 27 |
| | H&H | |
| May 18, 1998 | Calabrese-6 | 33 |
| | H&H | |
| May 18, 1998 | Calabrese-5 | 22 |
| | H&H test plot | |
| | sulfur/surfactate | |
| Jun. 23, 1998 | Calabrese 99821 | 19.7 |
| Jun. 29, 1998 | Deccico | 27.9 |
| | IVM 8015 | |
| Jun. 29, 1998 | Deccico | 16 |
| | IVM 8015 | |
| Jul. 23, 1998 | Calabrese | 6 |
| | BRO-1101 | |
| Jul. 23, 1998 | Calabrese | 23.1 |
| | BRO-1101 | |
| Jul. 23, 1998 | Calabrese | 10.4 |
| | BRO-1101 | |
| Jul. 23, 1998 | Calabrese | 1 |
| | BRO-1101 | |
| Jul. 23, 1998 | Calabrese | 3.6 |
| | BRO-1101 | |
| Jul. 23, 1998 | Calabrese | 7.4 |
| | 998824 | |
| Jul. 23, 1998 | Calabrese | 4.1 |
| | 998824 | |
| Jul. 23, 1998 | Calabrese | 22.8 |
| | 998824 | |
| Jul. 23, 1998 | Calabrese | 11.8 |
| | 998824 | |
| Jul. 23, 1998 | Calabrese | 11.9 |
| | 998824 | |
| Jul. 28, 1998 | Calabrese | 10.7 |
| | BRO-1101A | |
| Jul. 28, 1998 | Calabrese | 6.6 |
| | BRO-1201 | |
| Feb. 5, 2001 | Decicco | 20.7 |
| | BR-ORG-135811-PS | |

TABLE 3
Glucoraphanin Concentration of Seeds of Sampled
Broccoli Hybrid Varieties by HILIC

| | | P.I.C. |
|---|---|---|
| Date Sample | Brand/ | GR |
| Sent | Variety Name | μmol/g |
| Jul. 2, 1998 | Greenbelt | 1 |
| | Org. Broccoli | |
| Jul. 2, 1998 | Greenbelt | 17 |
| | Org. Broccoli | |
| Oct. 11, 1998 | Monte Cristo | 12.4 |
| | Rogers Variety | |
| Oct. 11, 1998 | Monte Cristo | 42.9 |
| | Rogers Variety | |
| Oct. 13, 1998 | OSX-440 Broc. | 45.8 |
| | Lot 198 | |
| | Ochoa Seed Co. | |
| | wide adaptability | |
| | Broader Greenbelt slot | |
| Oct. 13, 1998 | OSX-397 Broc. | 21.6 |
| | Lot 13 | |
| | Ochoa Seed | |
| | Greenbelt slot; | |
| | best warm-cold | |
| Oct. 13, 1998 | OSX-485 | 36.7 |
| | Lot GDR | |
| | Ochoa Seed | |
| | Greenbelt slots | |

The glucoraphanin content per gram of seed analyzed by the HILIC method for the broccoli varieties (provided in Tables 2 & 3) fall below the greater than 60 μmole of glucoraphanin per gram of seed (with an average range of 68-95 μmole of glucoraphanin per seed) of the broccoli variety ‘Hopkins’ analyzed by HILIC.

Demands in the pharmaceutical and biotech industry for increased productivity and throughput place more emphasis on the need to develop and validate robust HPLC methods. Method validation is completed to ensure that an analytical methodology is accurate, specific, reproducible and rugged over the specified range that an analyte will be analyzed. Method validation provides an assurance of reliability during normal use, and is sometimes referred to as “the process of providing documented evidence that the method does what it is intended to do.” Regulated laboratories must perform method validation in order to be in compliance with FDA regulations. In a 1987 guideline (Guideline for submitting Samples and Analytical Data For Methods Validation), the FDA designated the specifications in the current edition of the United States Pharmacopeia (USP) as those legally recognized when determining compliance with the Federal Food, Drug, and Cosmetic Act. For method validation, these specifications are listed in USP Chapter <1225>. In addition, since the first meeting of the International Conference on Harmonization of Technical Requirements For Registration of Pharmaceuticals For Human Use (ICH) in 1991, several guidelines have reached or approached the final stage of the ICH process that will impact the development and validation of HPLC methods. Some of these guidelines are already being implemented by the FDA. (SWARTZ, Waters Corporation, 34 Maple St., Milford, Mass. 01757)

To meet the above requirements, seed of the ‘Hopkins’ variety began testing by the C₁₈ Reverse-Phase HPLC method using a pure Glucoraphanin standard. Preliminary testing of the seed of the ‘Hopkins’ variety using the C₁₈ Reverse-Phase HPLC method has yielded consistent glucoraphanin results of greater than 80 μmole of glucoraphanin per gram of seed, within a range of 85-105 μmole of glucoraphanin per gram of seed. The preliminary results of ‘Hopkins’ seed analyzed using the C₁₈ Reverse-Phase HPLC method have yielded an increase in the amount of glucoraphanin detected per gram of seed by approximately 33% to 38%.

Preliminary testing using the improved HPLC method, C₁₈ Reverse-Phase HPLC, has been completed and compared to analyze the glucoraphanin concentration in seeds of the new broccoli variety ‘Hopkins’ to commercial broccoli varieties, ‘Marathon’ (unpatented) and ‘Calabrese’ (unpatented), and the analytical results are provided in Table 4 below.

TABLE 4
Glucoraphanin Concentration of Seeds of Sampled
Broccoli Varieties by C₁₈ Reverse-Phase HPLC

| | | P.I.C. |
|---|---|---|
| | Brand/ | GR |
| Analysis Date | Variety Name | μmol/g |
| Jul. 19, 2007 | Marathon | 83.4 |
| | Lot DM7-BR75 | |
| Jul. 19, 2007 | Hopkins | 96.7 |
| | Lot DM7-BR31 | |
| Jul. 03, 2007 | Calabrese | 67.6 |
| | Lot BRCA-107-W1 | |
| Jul. 23, 2007 | Hopkins | 98.7 |
| | Lot BRTN-107E | |

Additional analytical results of the glucoraphanin concentration detected by C₁₈ Reverse-Phase HPLC in broccoli seeds of other broccoli varieties have been published in the Journal of Agricultural and Food Chemistry (West et al, 2004). In West, et al. (2004), the commercial broccoli variety ‘Decicco’ was tested using the C₁₈ Reverse-Phase HPLC and the glucoraphanin concentration per gram of seed was determined to be 34.49 μmol.

The glucoraphanin content per gram of seed analyzed by the C₁₈ Reverse-Phase HPLC method for the broccoli varieties ‘Marathon’, ‘Calabrese’ and ‘Decicco’ fall below the greater than 85 μmole of glucoraphanin per gram of seed (with an average range of 85-105 μmole of glucoraphanin per seed) of the broccoli variety ‘Hopkins’ analyzed by C₁₈ Reverse-Phase HPLC method.

Thus, the new broccoli variety ‘Hopkins’ is unique over the currently, widely-available commercial broccoli varieties, ‘Marathon’, ‘Calabrese’ and ‘Decicco’, due to 1) the variety being highly inbred and highly self-compatible allowing the variety to easily reproduce or regenerate without the need for insect pollinations, 2) the high and consistent glucoraphanin content per seed, and 3) the consistent yield of seeds produced by ‘Hopkins’ with glucoraphanin levels which are greater than 60 μmole of glucoraphanin per gram of seed (with an average range of 68-85 μmole of glucoraphanin per gram of seed) when analyzed by Hydrophilic Interaction Liquid Chromatography (HILIC) and greater than 80 μmole of glucoraphanin per gram of seed (with an average range of 85-105 μmole of glucoraphanin per gram of seed) when analyzed by C₁₈ Reverse-Phase HPLC.

It should further be noted that differences in glucoraphanin measurements of seeds for broccoli varieties, including ‘Hopkins’, may vary due to a number of variables including, but not limited to, differences in the broccoli cultivar sample tested (i.e., growing location, season, age of plant, and storage environment) and methodology used for glucoraphanin analysis. As discussed above, the HPLC analytical methods are being continuously updated and modified to provide more accurate means for separation, identification, purification, and quantification of compounds. Likewise, the HPLC method will continue to be updated and modified in order to provide a more accurate analysis of the glucoraphanin content of seeds of the broccoli cultivar ‘Hopkins’.

### Example 4

### Description of ‘Hopkins’

‘Hopkins’ is the first broccoli variety developed solely as a producer of relatively inexpensive broccoli seed. All other current broccoli varieties are vegetable head producers that are not designed to produce seed. On the contrary, ‘Hopkins’ has a very poor horticultural phenotype, producing a relatively poor quality head. ‘Hopkins’ represents a broccoli variety more akin to an agronomic crop that is valued for its seed.

‘Hopkins’ is also very unique from other current broccoli varieties, which are virtually all F1 hybrids, in that it is a highly inbred line that is self-compatible. Whereas F1 hybrids do not generally produce seed (due to their self-incompatible nature), ‘Hopkins’ will breed true and produce large quantities of seed, making it easy to reproduce. Selfed-seed production by self-compatible individual broccoli plants was first documented by Moore and Anstey, Proc. Amer. Soc. Hort. Sci., 63:440-42 (1954); and then Gray, In Genetic Improvement of Vegetable Crops, pp. 61-86 (1993).

Broccoli seed produced by the new broccoli variety ‘Hopkins’ should represent a relatively inexpensive source of broccoli seed with a consistent, high concentration of glucoraphanin that can be used as sproutable seed or as a source of seed for glucosinolate extraction. In addition, the produced seed from ‘Hopkins’ can be processed as a food product (e.g., sprouts) or used to extract phytonutrients (e.g., glucoraphanin) from it.

As indicated above, seed produced by this variety will be used in the food, beverage processing industries wherein food or drink products, supplements or additives are manufactured or phytonutrients are extracted. Processors will be especially interested in the produced seed of ‘Hopkins’ as a relatively inexpensive raw material source with a consistently high glucoraphanin content. Further, the new broccoli variety ‘Hopkins’ could help enhance quality control for consistent high glucoraphanin content in the raw materials used for food processing by establishing a standard.

The new broccoli variety ‘Hopkins’ sets a new standard in broccoli breeding and selection programs by guaranteeing higher and more consistent levels of glucoraphanin than have previously been maintained. This will in turn aid sprout growers to increase sales of broccoli sprouts with enhanced anti-oxidant benefit to consumers. Sprouted ‘Hopkins’ broccoli seed will be processed, by a patented process developed with scientists at Johns Hopkins University, to extract relatively large quantities of super anti-oxidant glucoraphanin, with an ultimate goal to market the purified glucoraphanin as a food additive or for use in manufacturing as an supplement or food product.

‘Hopkins’ is not a conventional broccoli. The broccoli head that forms before this variety goes to flower is small and is probably not marketable as a vegetable broccoli head. ‘Hopkins’ is a niche market variety developed as a producer of relatively inexpensive seed that is well suited for making seedling sprouts or that might serve as raw materials for the extraction and purification of natural glucoraphanin.

Unlike almost all modern broccoli varieties, which are hybrids that express self-incompatibility, ‘Hopkins’ is a homogeneous, homozygous variety that is highly self-compatible and that sets seed without the aid of insect pollinators. In this regard, it is very different from its source population, ‘Italian Green Sprouting’, which produces very little seed in the absence of insect pollinators.

‘Hopkins’ produces plants that mature very uniformly. This also makes it distinct from ‘Italian Green Sprouting’, which exhibits wide variation for maturity and non-uniform ripening of seed that makes timely harvest difficult.

‘Hopkins’ also produces consistent yields of seeds. Pilot field trials with ‘Hopkins’ have measured seed yields as between 1,000 to 1,500 pounds per acre.

Compared to conventional varieties, ‘Hopkins’ would be best described as having early to mid-season maturity. It tends to head about one week or less after early hybrid varieties like ‘Captain’ or ‘Major’, and up to two weeks earlier than a late hybrid like ‘Marathon’.

Plants of the new broccoli variety ‘Hopkins’ were also compared to plants of the three different broccoli varieties ‘Pinnacle’ (unpatented), ‘Green Valiant’ (unpatented) and ‘Marathon’ (unpatented).

Plants of ‘Hopkins’ differ from plants of ‘Pinnacle’ as provided in Table 5:

TABLE 5

| Trait | ‘Hopkins’ | | ‘Pinnacle’ | |
|---|---|---|---|---|
| Maturity (Spring Planted) | | | | |
| Days from direct seeding to 50% harvest: | 90 | | 105 | |
| Days from transplanting to 50% harvest: | 58 | | 65 | |
| Maturity (Fall Planted) | | | | |
| Days from direct seeding to 50% harvest: | 105 | | 120 | |
| Days from transplanting to 50% harvest: | 73 | | 80 | |
| Plant (At Harvest) | | | | |
| Plant height: | 65.8 | cm | 62.0 | cm |
| Head height: | 44.3 | cm | 46.0 | cm |
| Quantity of plant branches: | Medium amount | | Few amount | |
| Market class: | Production of Seed | | Fresh market; processing | |
| Type of variety: | Self-compatible inbred | | F1 generation Hybrid | |
| Outer Leaves (At Harvest) | | | | |
| Number of leaves per plant: | 17 | | 19 | |
| Width (at Midpoint of plant incl. petiole): | 22.5 | cm | 21.3 | cm |
| Length (at midpoint of plant incl. petiole): | 56.5 | cm | 54.6 | cm |
| Petiole Length: | 23.0 | cm | 25.3 | cm |
| Head (At Market Maturity) | | | | |
| Diameter: | 12.73 | cm | 11.66 | cm |
| Depth: | 5.99 | cm | 6.52 | cm |
| Weight (marked trimmed): | 118.2 | g | 198.4 | cm |

| | | |
|---|---|---|
| Shape: | Transverse Elliptic | Transverse Broad Elliptic |
| Dome shape: | Domed | Semi-domed |
| Head size: | Small | Medium |
| Compactness: | Long Pedicels (loose) | Short Pedicels (tight) |
| Bead size: | Large | Medium |
| Secondary heads: | Axillary along entire | Basal |
| | stem up to main head | |

Plants of ‘Hopkins’ differ from plants of ‘Green Valiant’ as provided in Table 6:

TABLE 6

| Trait | ‘Hopkins’ | | ‘Green Valiant’ | |
|---|---|---|---|---|
| Maturity (Spring Planted) | | | | |
| Days from direct seeding to 50% harvest: | 90 | | 103 | |
| Days from transplanting to 50% harvest: | 58 | | 63 | |
| Maturity (Fall Planted) | | | | |
| Days from direct seeding to 50% harvest: | 105 | | 120 | |
| Days from transplanting to 50% harvest: | 73 | | 78 | |
| Plant (At Harvest) | | | | |
| Plant height: | 65.8 | cm | 61.6 | cm |
| Head height: | 44.3 | cm | 40.0 | cm |
| Quantity of plant branches: | Medium amount | | Few amount | |
| Market class: | Production of Seed | | Fresh market; processing | |
| Type of variety: | Self-compatible inbred | | F1 generation hybrid | |
| Outer Leaves (At Harvest) | | | | |
| Number of leaves per plant: | 17 | | 20 | |
| Width (at Midpoint of plant incl. petiole): | 22.5 | cm | 18.0 | cm |
| Length (at midpoint of plant incl. petiole): | 56.5 | cm | 52.2 | cm |
| Petiole Length: | 23.0 | cm | 23.3 | cm |
| Head (At Market Maturity) | | | | |
| Diameter: | 12.73 | cm | 11.64 | cm |
| Depth: | 5.99 | cm | 5.55 | cm |
| Weight (marked trimmed): | 118.2 | g | 222.0 | cm |

| | | |
|---|---|---|
| Shape: | Transverse Elliptic | Transverse Elliptic |
| Dome shape: | Domed | Semi-domed |
| Head size: | Small | Medium |
| Compactness: | Long Pedicels (loose) | Short Pedicels (tight) |
| Bead size: | Large | Medium |
| Secondary heads: | Axillary along entire | Axillary along most of the |
| | stem up to main head | stems, less than ‘Hopkins’ |
| | | variety |

Plants of ‘Hopkins’ differ from plants of ‘Marathon’ as provided in Table 7:

TABLE 7

| Trait | ‘Hopkins’ | | ‘Marathon’ | |
|---|---|---|---|---|
| Maturity (Spring Planted) | | | | |
| Days from direct seeding to 50% harvest: | 90 | | 110 | |
| Days from transplanting to 50% harvest: | 58 | | 70 | |
| Maturity (Fall Planted) | | | | |
| Days from direct seeding to 50% harvest: | 105 | | 130 | |
| Days from transplanting to 50% harvest: | 73 | | 96 | |
| Plant (At Harvest) | | | | |
| Plant height: | 65.8 | cm | 63.2 | cm |
| Head height: | 44.3 | cm | 45.7 | cm |
| Quantity of plant branches: | Medium amount | | Few amount | |
| Market class: | Production of Seed | | Fresh market | |
| Type of variety: | Self-compatible inbred | | F1 generation hybrid | |
| Outer Leaves (At Harvest) | | | | |
| Number of leaves per plant: | 17 | | 22 | |
| Width (at Midpoint of plant incl. petiole): | 22.5 | cm | 17.0 | cm |
| Length (at midpoint of plant incl. petiole): | 56.5 | cm | 52.3 | cm |
| Petiole Length: | 23.0 | cm | 23.0 | cm |
| Head (At Market Maturity) | | | | |
| Diameter: | 12.73 | cm | 11.8 | cm |
| Depth: | 5.99 | cm | 5.1 | cm |
| Weight (marked trimmed): | 118.2 | g | 210.0 | cm |

| | | |
|---|---|---|
| Shape: | Transverse Elliptic | Tranverse Broad Elliptic |
| Dome shape: | Domed | Domed |
| Head size: | Small | Medium |
| Compactness: | Long Pedicels (loose) | Medium |
| Bead size: | Large | Medium |
| Secondary heads: | Axillary along entire | Completely absent |
| | stem up to main head | |

The new broccoli variety ‘Hopkins’ has not been observed under all possible environmental conditions. The characteristics of the new variety may vary in detail, depending upon variations in environmental factors, including weather (temperature, humidity and light intensity), day length, soil type and location.

Yield observations and plant characteristics were taken over a four (4) year period of data collected from the 2002 through 2005 growing seasons at the USVL in Charleston, S.C. The age of the plants described is at the fresh market stage.

Color terminology follows the Munsell Book of Colors, 1976, Munsell Color, Baltimore, Md., when using electronic Licore measuring.

Other phenotypic characteristics of the new broccoli variety ‘Hopkins’ are shown in Table 8.

TABLE 8

| MATURITY: | | |
|---|---|---|
| Harvest season: | Spring/Summer | |
| Maturity (Spring Planted) | | |
| Days from direct seeding to 50% harvest: | 90 | |
| Days from transplanting to 50% harvest: | 58 | |
| Maturity (Fall Planted) | | |
| Days from direct seeding to 50% harvest: | 105 | |
| Days from transplanting to 50% harvest: | 73 | |
| SEEDLING: | | |
| Cotyledon Color: | Medium Green | |
| Cotyledon Anthocyanin: | Weak | |
| Hypocotyl Anthocyanin: | Absent | |
| PLANT: | | |
| Plant height: | 65.8 | cm |
| Head height: | 44.3 | cm |
| Quantity of plant branches: | Medium amount | |
| Plant habit: | Intermediate | |
| Market class: | Production of Seed | |
| Life cycle: | Annual | |
| Type of variety: | Self-compatible inbred | |
| OUTER LEAVES (At Harvest): | | |
| Number of leaves per plant: | 17 | |
| Width (at Midpoint of plant incl. | 22.5 | cm |
| petiole): | | |
| Length (at midpoint of plant incl. | 56.5 | cm |
| petiole): | | |
| Petiole Length: | 23.0 | cm |
| HEAD (At Market Maturity): | | |
| Diameter: | 127.3 | cm |
| Depth: | 59.9 | cm |
| Weight (marked trimmed): | 118.2 | g |

| | |
|---|---|
| Color: | Light/medium green, |
| | 7.3 GY 4.0 2.5 |
| Shape: | Transverse Elliptic |
| Dome shape: | Domed |
| Head size: | Small |
| Compactness: | Long Pedicels (loose) |
| Surface Knobbling: | Medium |
| Bead size: | Large |
| Flower Buds: | Even in size |
| Anthocyanin Coloration: | Absent |
| Leaf axils: | Absent |
| Leaf veins: | Absent |
| Leaf blade: | Absent |
| Leaf petiole: | Absent |
| Entire plant: | None |
| Color of head leaves: | Axillary along entire |
| | stem up to main head |
| Secondary heads: | Weak |
| Prominence of secondary heads: | |
| FLOWER: | |
| Size (buds just prior to anthesis): | Medium, 1.0 cm in length |
| Size (flowers fully open) | Medium, 2.5-3.0 cm in |
| | diameter (from tip of |
| | one petal to the tip of |
| | the opposite petal) |
| Flower color: | Yellow, 9.0 Y 7.7 7.3 |
| Flower stalk color: | Green, 5.0 GY 5.2 4.6 |
| DISEASE/PEST RESISTANCE: | Resistant to white mold, |
| | Sclerotinia. |
| DISEASE/PEST SUSCEPTIBILITY: | Susceptible to downy mildew. |

The examples described herein are illustrative of the present invention and are not intended to be limitations thereon. Different embodiments of the present invention have been described according to the present invention. Many modifications and variations may be made to the methods and plants described and illustrated herein without departing from the spirit and scope of the invention.

Although the foregoing refers to particular preferred embodiments, it will be understood that the present invention is not so limited. It will occur to those of ordinary skill in the art that various modifications may be made to the disclosed embodiments and that such modifications are intended to be within the scope of the present invention, which is defined by the following claims. All publications and patent applications mentioned in this specification are indicative of the level of skill of those in the art to which the invention pertains.

All publications and patent applications are herein incorporated by reference to the same extent as if each individual publication or patent application were specifically and individually indicated to be incorporated by reference in its entirety.

What is claimed is:

1. A method of producing a food or drink product, supplement or additive comprising the step of incorporating plant parts or whole plants from the Brassica oleracea L. (Italica group) broccoli variety ‘Hopkins’ into said food or drink product, supplement or additive.

2. The method of claim 1, wherein said plant parts are selected from the group consisting of seeds, sprouts, leaves and mature heads.

3. The method of claim 1, wherein said plant parts are seed with a consistent high glucoraphanin concentration of greater than 50 μmole of glucoraphanin per gram of seed.

4. The method according to claim 1, wherein said food or drink product, supplement or additive is selected from the group consisting of juices, smoothies, shakes, teas, soups, sauces, sandwiches, salads, granolas, cereals, breads, other baked goods, fried goods, pills and tablets, sprays and other ingestible products, supplements and additives.

5. The method according to claim 1, wherein the said step of incorporation is combining said plant parts or whole plants with other ingredients.

6. The method according to claim 1, where said step of incorporation is drying or grinding said plant parts or whole plants and then combining with other ingredients.

7. The method according to claim 1, wherein said step of incorporation is extraction of said plant parts or whole plants with a solvent to obtain glucosinolates or isothiocyanates and combining said glucosinolates or isothiocyanates extract with other ingredients.

8. A food or drink product, supplement or additive comprising plant parts or whole plants of the broccoli variety ‘Hopkins’.

9. A food or drink product, supplement or additive comprising an extract obtained from plant parts or whole plants of the broccoli variety ‘Hopkins’.
